(19) United States
(12) Patent Application Publication
(10) Pub. No.: US 2013/0081262 A1
(43) Pub. Date: Apr. 4, 2013

(54) MANUFACTURING METHOD FOR TOTATING DEVICE HAVING IMPROVED QUALITY

(71) Applicant: Alphana Technology Co., Ltd., Shizuoka (JP)

(72) Inventors: Yasuo FUKUZAKO, Shizuoka (JP); Kazumasa AIKAWA, Shizuoka (JP)

(73) Assignee: ALPHANA TECHNOLOGY CO., LTD., Shizuoka (JP)

(21) Appl. No.: 13/630,414

(22) Filed: Sep. 28, 2012

(30) Foreign Application Priority Data
Sep. 29, 2011 (JP) 2011-215132

(51) Int. Cl. G11B 5/127

(52) U.S. Cl. 29/603.16

(57) ABSTRACT

With at least one from among a base member and a hub member as a workpiece, a manufacturing method for a rotating device including a hub member on which a recording disk is to be mounted and a base member configured to rotatably support the hub member via a bearing unit comprises: a cutting step in which a cutting water agent is applied while the workpiece is being cut; a removing step in which the cutting water agent that remains adhered to the workpiece after cutting is removed; and an assembling step in which the rotating device is assembled using the workpiece after removing the cutting water agent.

### CROSS-REFERENCE TO RELATED APPLICATIONS

This application is based upon and claims the benefit of priority from the prior Japanese Patent Application No. 2011-215132, filed on Sep. 29, 2011, the entire content of which is incorporated herein by reference.

### BACKGROUND OF THE INVENTION

1. Field of the Invention

The present invention relates to a manufacturing technique for a rotating device, and particularly to a technique for providing improved quality of such a rotating device without increasing the number of manufacturing steps.

2. Description of the Related Art

In recent years, by providing a fluid dynamic bearing unit, rotating devices such as HDDs or the like have come to have dramatically improved rotation accuracy. Accompanying this dramatic improvement in the rotation accuracy, there is a demand for such a rotating device to have higher data density and higher data capacity. For example, with a HDD configured to magnetically store data, a recording disk on which recording tracks are formed is rotated at high speed. With such an arrangement, a magnetic head is configured to execute data reading/writing operations by tracing the recording tracks with a small floating gap between the magnetic head and the recording disk. In order to configure such a HDD with high data density and high data capacity, there is a need to narrow the width of each recording track. Furthermore, as the track width becomes narrower, there is a need to further narrow the gap between the magnetic head and the recording disk. For example, there is a demand to configure the magnetic head and the recording disk with a very small gap of 10 nm or less between them, giving consideration to data reading/writing reliability. Thus, high precision is required in terms of the dimensions and flatness of each component of such a HDD.

In many cases, such a component of a rotating device such as a HDD or the like, the dimensions of which are required to have high precision, is manufactured by means of cutting or the like. For example, in a case of manufacturing a hub configured to rotate at a high speed with a recording disk mounted on it, a material such as iron or the like is cut so as to ensure desired precision in terms of its dimensions and flatness (see Japanese Patent Application Laid Open No. 2000-117502, for example). Typically, such a cutting operation is performed while supplying a cutting oil agent to a space between a material (which will be referred to as the “workpiece” hereafter) and a cutting tool so as to reduce the cutting resistance in the cutting operation, thereby providing improved cutting accuracy, and thereby reducing damage to the workpiece or to such a cutting tool.

With such a HDD including a magnetic head and a recording disk configured with a very small gap between them, even if there is a very small quantity of a contaminant on the magnetic head, the recording disk, or in the gap between them, such a contaminant leads to data read/write error. In some cases, a contaminant is introduced in the assembly of a HDD, and in some cases, a contaminant adheres to a component of a HDD. By providing an improved assembly environment, e.g., by providing a clean room as an assembly environment, the addition of contaminants can be suppressed in the assembly stage. On the other hand, in a case in which a contaminant has adhered to a given component of a HDD, for example, in a case in which a contaminant has adhered to such a component in the manufacturing process, there is a need to provide a cleaning stage for such a component after the manufacturing process. Furthermore, there is a need to provide a step for checking whether or not a contaminant has adhered to such a component after the cleaning liquid is removed in a drying stage. As a result, cleaning the workpiece leads to increased manufacturing time and increased manufacturing costs.

In some cases, the adherence of a contaminant occurs in the manufacturing process for HDD components due to hydrocarbon compounds contained in a cutting oil agent. For example, in a case in which hydrocarbon compounds contained in the cutting oil agent remain as a residue on the surface of a hub, these hydrocarbon compounds volatilize and migrate within the HDD with the passage of time, and in some cases, they adhere to the recording face of the recording disk. As a result, this leads to data read/write error.

After various kinds of experiments involving data read/write error, the present inventors have reached a conclusion that, in order to provide a HDD having a large capacity, there is a need to reduce the retention of hydrocarbon compound contaminants that adhere to the components of a HDD such as a hub and so forth, particularly with respect to components having a surface exposed to the interior of the HDD. It should be noted that, in order to reduce the adherence of hydrocarbon compound contaminants, a method for providing a cleaning step or the like can be conceived. However, such a cleaning method requires a very long time to reduce the adherence of hydrocarbon compound contaminants to a level which ensures that data read/write error does not occur. Thus, such a method with a long cleaning time leads to degraded manufacturing efficiency, which is undesirable. Furthermore, such a cleaning method requires a high-cost cleaning fluid. Thus, a long cleaning time leads to increased manufacturing costs. Thus, the present inventors have reached a conclusion that there is a need to provide a drastic method for reducing hydrocarbon compound contamination.

### SUMMARY OF THE INVENTION

The present invention has been made in view of such a situation. Accordingly, it is a general purpose of the present invention to provide a manufacturing method for a rotating device having improved quality without increasing the number of manufacturing steps, without increasing manufacturing costs, and so forth.

In order to solve the aforementioned problem, a manufacturing method for a rotating device according to an embodiment of the present invention is configured as a manufacturing method for a rotating device including a hub member on which a recording disk is to be mounted and a base member configured to rotatably support the hub member via a bearing unit. With at least one from among the base member and the hub member as a workpiece, the manufacturing method comprises: cutting, in which a cutting water agent is applied while the workpiece is being cut; removing, in which the cutting water agent that remains adhered to the workpiece after cutting is removed; and assembling, in which the rotating device is assembled using the workpiece after the removing of the cutting water agent.

With such an embodiment, at least one of the components of the rotating device which is to involve the recording disk is manufactured by a cutting process using a cutting water agent. Thus, such an arrangement is capable of reducing the amount of residual hydrocarbon compounds, as compared with a conventional cutting process using a cutting oil agent including hydrocarbon compounds. As a result, such an arrangement prevents the quality of the rotating device from degrading due to the residual hydrocarbon compounds.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory diagram for describing an internal configuration of a disk driving apparatus (HDD) which is an example of a rotating device manufactured using a manufacturing method according to the present embodiment;

FIG. 2 is a cross-sectional diagram for describing an internal configuration directing attention to a bearing unit of the disk driving apparatus shown in FIG. 1;

FIG. 3 is an explanatory diagram for describing a process sequence of a manufacturing method according to the present embodiment; and

FIG. 4 is an explanatory diagram which shows an example of a cutting process using a cutting water agent employed in the manufacturing method according to the present embodiment.

### DETAILED DESCRIPTION OF THE INVENTION

The invention will now be described by reference to the preferred embodiments. This does not intend to limit the scope of the present invention, but to exemplify the invention.

Description will be made regarding a preferred embodiment of the present invention with reference to the drawings. The same or similar components and members are denoted by the same reference numerals, and redundant description thereof will be omitted as appropriate. It should be noted that the scale of the components shown in the drawings is expanded or reduced as appropriate for ease of understanding. Also, a part of the components that are not essential for describing the embodiment are not shown in the drawings.

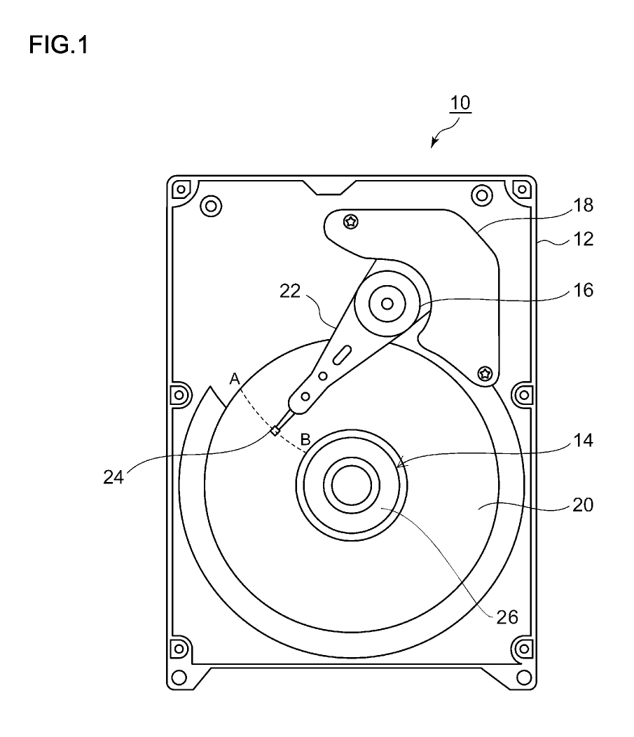

FIG. 1 is an explanatory diagram for describing an internal configuration of a disk driving apparatus 10 (hard disk drive apparatus: HDD) which is an example of a rotating device manufactured using a manufacturing method according to the present embodiment. FIG. 1 shows a disk driving apparatus 10 without a cover in order to show the internal configuration.

A brushless motor 14, an arm bearing unit 16, a voice coil motor 18, and so forth, are mounted on the top face of a base member 12. The brushless motor 14 is configured to support, on its axis of rotation, a hub member 26 configured to mount a recording disk 20, and to rotationally drive a recording disk 20 configured to magnetically store data, for example. The brushless motor 14 may be configured as a spindle motor, for example. The brushless motor 14 is configured to rotationally drive the recording disk 20. The brushless motor 14 is driven using three-phase driving current having phases U, V, and W. The arm bearing unit 16 is configured to support a swing arm 22 such that the swing arm 22 can swing in a movable range AB. The voice coil motor 18 is configured to swing the swing arm 22 according to external control data. A magnetic head 24 is mounted at the end of the swing arm 22. When the disk driving apparatus 10 is operated, the magnetic head 24 moves in the movable range AB with a gap between it and the surface of the recording disk 20 according to the swing of the swing arm 22 so as to allow data to be read and written. It should be noted that, in FIG. 1, the point A corresponds to the position of the outermost recording track of the recording disk 20, and the point B corresponds to the position of the innermost recording track thereof. When the operation of the disk driving apparatus 10 is stopped, the swing arm 22 may be moved to a retracted position provided to the side of the recording disk 20.

It should noted that, in the present embodiment, in some cases, an arrangement including all the components such as the recording disk 20, swing arm 22, magnetic head 24, voice coil motor 18, and so forth, required for data reading/writing operations, will be referred to as the “disk driving apparatus 10 (rotating device)”. In some cases, such an arrangement will be referred to as the “HDD”. Also, in some cases, only a mechanism configured to rotationally drive the recording disk 20 will be referred to as the disk driving apparatus 10 (rotating device).

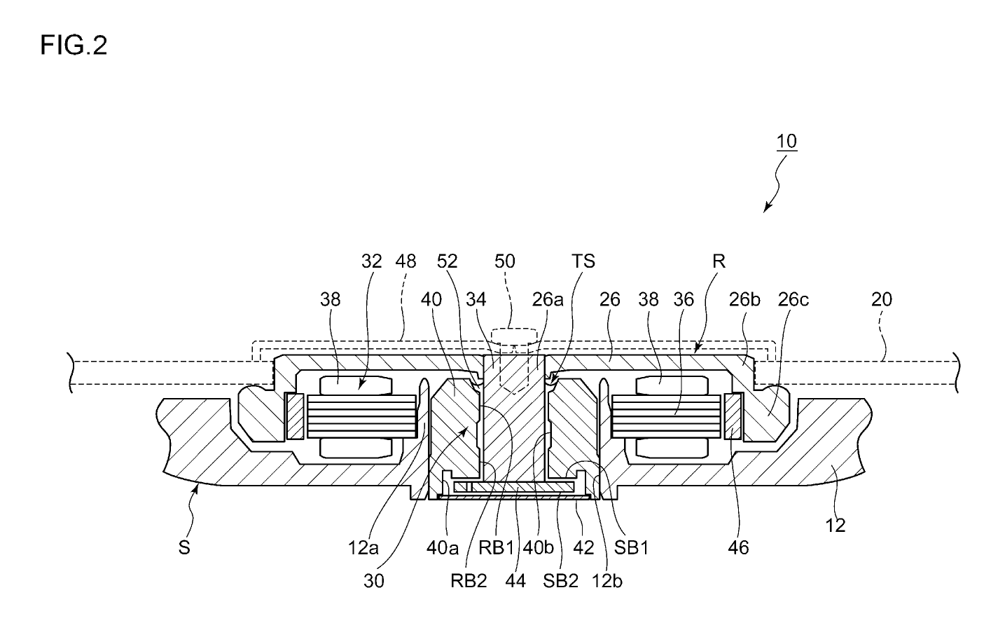

FIG. 2 is a cross-sectional diagram for describing an internal configuration focusing on the bearing unit of the disk driving apparatus 10 shown in FIG. 1.

As shown in FIG. 2, the disk driving apparatus 10 according to the present embodiment comprises a stator unit S, a rotor unit R, a bearing unit 30 comprising a radial fluid dynamic pressure bearing unit composed of radial dynamic pressure grooves RB1 and RB2 including a lubricant agent and a thrust fluid dynamic pressure bearing unit composed of thrust dynamic pressure grooves SB1 and SB2, and a driving unit 32 configured to rotationally drive the rotor unit R relative to the stator unit S via the fluid dynamic bearing units. FIG. 2 shows a configuration of a so-called shaft-rotating disk driving apparatus 10 configured such that the hub member 26 configured to support the recording disk 20 and the shaft 34 are rotationally driven as a single unit, as an example. It should be noted that each component of the disk driving apparatus 10 is classified based on its function. In this classification, a component may be included in multiple classified groups such as the stator unit S, the bearing unit 30, the rotor unit R, and the driving unit 32, for example. For example, the shaft 34 is included in the rotor unit R, as well as being included in the bearing unit 30.

The stator unit S is configured including a base member 12, a stator core 36, a coil 38, a sleeve 40, and a counter plate 42. The stator core 36 is fixed to the outer wall of a cylindrical unit 12a formed on the base member 12. The sleeve 40 is configured as a cylindrical member, and is formed of a metal material or a resin material having electrical conductivity. The outer face of the sleeve 40 constitutes the outer face of the bearing unit 30 described later. The bearing unit 30 is fixed by means of an adhesive agent or the like to a bearing hole 12b defined by the inner wall of the cylindrical unit 12a formed in the base member 12. The disk-shaped counter plate 42 is fixed to one end of the sleeve 40, which seals the interior side of the base member 12 on which the recording disk 20 or the like is to be mounted.

The base member 12 can be formed by cutting a part of a base material manufactured by means of aluminum die casting after the manufactured base material is subjected to epoxy resin surface coating, by pressing an aluminum plate, or otherwise by pressing an iron plate and performing nickel plating on the iron plate thus pressed. The stator core 36 is manufactured by stacking multiple magnetic plate members such as silicon steel plates, and by performing insulating surface coating on the magnetic plate members thus stacked by means of electrodeposition coating, powder coating, or the like. Furthermore, the stator core 36 is configured as a ring-shaped member having multiple salient poles (not shown) protruding outward along the radial direction. A coil 38 is formed at each salient pole. For example, in a case in which the disk driving apparatus 10 is configured to perform a three-phase driving operation, the number of salient poles is determined to be nine. It should be noted that the winding terminal of the coil 38 is connected to an FPC (not shown) arranged on the bottom face of the base member 12 by soldering.

The rotor unit R has a configuration including the hub member 26, the shaft 34, a flange 44, and a magnet 46. The hub member 26 is configured in an approximately cup-like shape, and includes an outer-face cylindrical portion 26b arranged concentrically around a central hole 26a, and an outer extension portion 26c extending outward from the lower end of the outer-face cylindrical portion 26b. Furthermore, the ring-shaped magnet 46 is fixed to the inner wall of the outer extension portion 26c. The hub member 26 can be formed by cutting a metal member formed of stainless steel, aluminum, iron, or the like. It should be noted that the hub member 26 can be formed of an electrically conductive resin by molding or machining. The magnet 46 is formed of a material such as a Nd—Fe—B (neodymium-iron-boron) system, for example, and is subjected to anti-corrosion surface processing by means of electro coating, spray coating, or the like. With the present embodiment, the magnet 46 is configured such that 12 magnetic poles are formed on the inner face thereof.

The shaft 34 is arranged such that one end thereof is fixed at the central hole 26a formed in the hub member 26, and the disk-shaped flange 44 is fixed to the other end thereof. The shaft 34 can be formed of a metal member having electrical conductivity such as a stainless steel member or the like, for example. The flange 44 can be formed of a metal material or a resin material having electrical conductivity. A flange housing space 40a for housing the flange 44 is formed at one end of the sleeve 40. Thus, the sleeve 40 is configured to rotatably support the shaft 34 to which the flange 44 is fixed, facing a space enclosed by the cylindrical inner wall 40b and the flange housing space 40a.

The shaft 34 with the flange 44, which is a component of the rotor unit R, is inserted along the cylindrical inner wall 40b of the sleeve 40 of the stator unit S. As a result, the rotor unit R is rotatably supported by the stator unit S via the radial fluid dynamic pressure bearing unit composed of the radial dynamic pressure grooves RB1 and RB2 and including a lubricant agent, and a thrust fluid dynamic pressure bearing unit composed of the thrust dynamic pressure grooves SB1 and SB2 and including a lubricant agent. The driving unit 32 has a configuration including the stator core 36, the coil 38, and the magnet 46. With such an arrangement, the hub member 26, the stator core 36, and the magnet 46 form a magnetic circuit. Thus, by sequentially supplying electric power to each coil 38 by means of the control operation of an external driving circuit, such an arrangement allows the rotor unit R to be rotationally driven.

It should be noted that, with the present embodiment, the outer-face cylindrical unit 26b of the hub member 26 is configured to be engaged with the central hole of the recording disk 20, and the outer extension portion 26c is configured to support the recording disk 20 at a predetermined position. Furthermore, a clamper 48 is configured to be pressed into contact with the upper face of the recording disk 20. The clamper 48 is fixed to the hub member 26 by a screw 50. In this state, the recording disk 20 is fixedly mounted on the hub member 26, which allows the recording disk 20 to be rotated together with the hub member 26.

Next, description will be made regarding the bearing unit 30.

The bearing unit 30 has a configuration including the shaft 34, the flange 44, the sleeve 40, and the counter plate 42. The cylindrical inner wall 40b of the sleeve 40 and the outer face of the shaft 34 that faces the cylindrical inner wall 40b constitute a radial space portion. Furthermore, the radial dynamic pressure grooves RB1 and RB2 are formed in at least one from among the cylindrical inner wall 40b of the sleeve 40 and the outer face of the shaft 34, which allows dynamic pressure to be generated so as to support the shaft 34 along the radial direction. The radial dynamic pressure groove RB1 is formed on the side nearer to the hub member 26, and the radial dynamic pressure groove RB2 is formed on the side farther from the hub member 26. The radial dynamic pressure grooves RB1 and RB2 are each configured as a herringbone groove or a spiral groove arranged separated from each other along the axis direction of the shaft 34. The space formed by the radial dynamic pressure grooves RB1 and RB2 is filled with a lubricant agent 52 such as oil or the like. Thus, by rotating the shaft 34, such an arrangement is configured to generate a high pressure portion in the lubricant agent 52. The pressure thus generated allows the shaft 34 to float on the surrounding wall, thereby providing a substantially contactless rotating state of the shaft 34 floating along the radial direction.

As described above, the flange 44 is fixed at the lower end of the shaft 34 such that the flange 44 is rotated together with the shaft 34 as a single unit. Furthermore, the middle portion of the bottom face of the sleeve 40 constitutes the flange housing space 40a configured to house the flange 44 such that it is rotatably supported. One end of the flange housing space 40a is sealed by the counter plate 42, which maintains the airtightness of the flange housing space 40a and the airtightness of the housing space for the shaft 34 which communicates with the flange housing space 40a.

The thrust dynamic pressure groove SB1 is formed in at least one from among the face of the flange 44 and the face of the sleeve 40 that face each other along the axis direction. Furthermore, the thrust dynamic pressure groove SB2 is formed in at least one from among of the face of the flange 44 and the face of the counter plate 42 that face each other. Such a mechanism formed of the thrust dynamic pressure grooves SB1 and SB2 including the lubricant agent 52 functions as the thrust fluid dynamic pressure bearing unit. The thrust dynamic pressure grooves SB1 and SB2 are each configured as a spiral groove or a herringbone groove. Such an arrangement allows pump-in dynamic pressure to be generated. That is to say, by rotating the flange 44, which is a component of the rotor unit R, relative to the sleeve 40 and the counter plate 42, which are components of the stator unit S, such an arrangement generates pump-in dynamic pressure. As a result, the dynamic pressure thus generated provides a substantially contactless state of the rotor unit R including the flange 44, floating on the stator unit S along the axis direction, with a predetermined gap between the stator unit S and the rotor unit R. In this state, the rotor unit R including the hub member 26 is supported in a contactless state with respect to the stator unit S.

With the present embodiment, the lubricant agent 52 with which the space is filled is shared by the radial fluid dynamic pressure bearing unit and the thrust fluid dynamic pressure bearing unit. The open end of the sleeve 40 forms a capillary sealing portion TS having a tapered structure configured such that the gap between the inner face of the sleeve 40 and the outer face of the shaft 34 gradually extends outward as it approaches the open end. Furthermore, the space that includes the radial dynamic pressure grooves RB1 and RB2, the space that includes the thrust dynamic pressure grooves SB1 and SB2, and a part of the capillary sealing portion TS are filled with the lubricant agent 52. The capillary sealing portion TS is configured to prevent the lubricant agent 52 from leaking, due to the capillary action, from the filled space to the exterior.

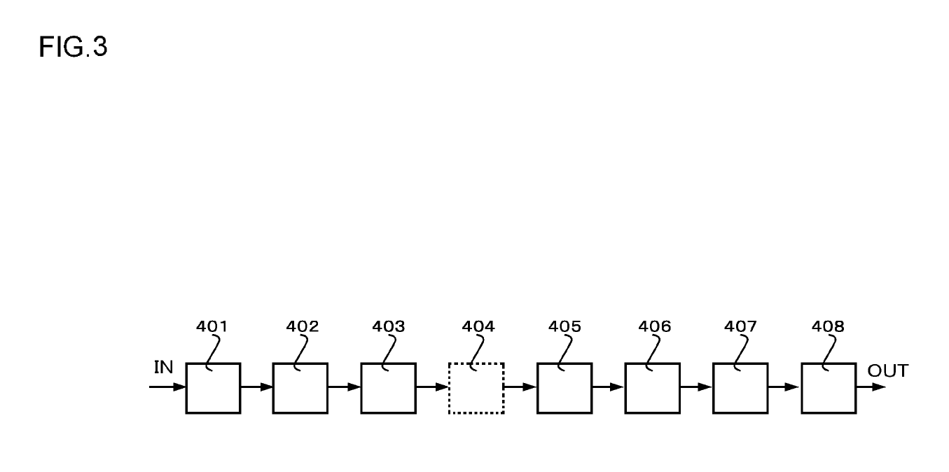

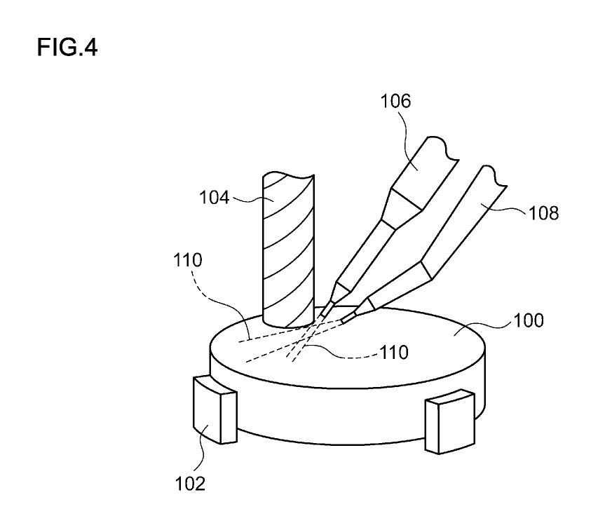

Description will be made with reference to FIGS. 3 and 4 regarding a manufacturing method for the disk driving apparatus 10 configured as described above.

As described above, one reason why operation error such as read/write error occurs in the disk driving apparatus 10 is that the cutting oil agent used in the cutting process for each component of the disk driving apparatus 10 contains hydrocarbon compounds. Thus, the present inventors have reached a conclusion based upon various kinds of experimental results that an essential countermeasure is to employ cutting water, which can be assumed to contain a negligibly small amount of hydrocarbon compounds (substantially no hydrocarbon compounds). Based upon the experimental results, the present inventors have reached a conclusion that, by processing the workpiece by cutting while supplying a cutting water agent with a controlled pH ranging between 5 and 11 and containing a negligibly small amount of hydrocarbon compounds, such a cutting process allows the amount of hydrocarbon compounds that adhere to the workpiece to be greatly reduced in the cutting process. It should be noted that, in the following description in the present embodiment, at least one from among the base member 12, the hub member 26, and the bearing unit 30 including the radial fluid dynamic pressure bearing and the thrust fluid bearing unit, which are components of the disk driving apparatus 10, will be referred to as the “workpiece”. Description will be made in the present embodiment regarding an arrangement in which the hub member 26 is subjected to the cutting process as such a workpiece, as an example.

Based upon various kinds of experimental results, the present inventors have reached a conclusion that the cutting water agent to be used in the present embodiment is preferably controlled so as to have a mild alkaline pH ranging between 8 and 10, which is suitable for the workpiece cutting process. Such alkaline cutting water can be generated using a catalytic environment mechanism using water (preferably pure water), photocatalysis, and artificial zeolite. It should be noted that such an alkaline cutting water agent may be generated by means of other known methods such as an electrolysis method. Furthermore, with the present embodiment, such a cutting water agent is configured as a liquid obtained by adding a water-soluble synthetic agent to alkaline water. For example, a liquid obtained by adding diethanolamine, which is a component that functions as an anti-corrosion agent, to such alkaline water with a volume ratio of 0.3%-1.0%, and by further adding phosphoric acid with a volume ratio of 0.05%-0.5, is employed as a cutting water agent. Furthermore, an additive agent may be added so as to provide improved lubricity. As such an additive agent, non-ionic water-soluble cellulose ether, e.g., metolose, may be added with a volume ratio of 0.5%-1.0%.

Such an alkaline cutting water agent provides an anti-corrosion effect, which allows a cutting machine or related equipment to be protected from the occurrence of corrosion such as rust. Furthermore, a liquid which can be assumed to contain substantially no hydrocarbon compounds is employed as a cutting water agent, thereby allowing foreign substances or impurities, and oil that originally adhered to the workpiece before the cutting process, to be removed from the workpiece in the cutting process. In addition, the basic component of the cutting water agent is water. Thus, such a cutting water agent does not become a source of impurities on the floor or wall, or on the surrounding machinery and tools, even if the cutting water agent scatters in the cutting process. Thus, such an arrangement does not damage the manufacturing environment, which is another advantage.

It should be noted that the cutting water agent to be used in the present embodiment is obtained by adding a water-soluble synthetic agent to alkaline water. The present inventors have obtained an experimental result indicating that, if such a water-soluble synthetic agent is not added, with the passage of time, such an alkaline cutting water agent absorbs carbon dioxide contained in the atmosphere, leading to degradation of its alkalinity, together with quality-degrading large variations. In contrast, the present inventors have obtained an experimental result indicating that such an arrangement employing a cutting water agent obtained by adding such a water-soluble synthetic agent to alkaline water does not lead to such degradation in the alkalinity even with the passage of time, i.e., it allows the alkalinity to be stably maintained over time.

Based upon various kinds of experimental results, the present inventors have affirmed that in an arrangement employing a cutting water agent having a strongly acidic pH of 4 or less, rust occurs in the equipment and so forth. On the other hand, the present inventors have affirmed that in an arrangement employing a cutting water agent having a strongly alkaline pH of 11 or more, the surface of the workpiece becomes discolored during or otherwise after the cutting process. Furthermore, the present inventors have affirmed that, in a case of employing an alkaline cutting water agent, once impurities are removed, the workpiece rarely becomes recontaminated, as compared with an arrangement employing an acidic cutting water agent. Thus, the present inventors have reached a conclusion that, with a margin based upon the experimental results, the cutting water agent to be used in the present embodiment is preferably controlled so as to have a pH ranging between 8 and 10, and more preferably controlled so as to have a pH ranging between 8.5 and 9.5. It should be noted that the present inventors have affirmed that a water-soluble synthetic agent including, as a principal element, at least one from among phosphoric acid, carboxylic acid, a sulfonate, an alcohol, and an ester can preferably be employed in order to provide an anti-corrosive effect.

By performing such a cutting process with such a cutting water agent supplied as described above, such an arrangement is capable of effectively reducing the amount of hydrocarbon compounds that remain adhered to the workpiece. As a result, such an arrangement facilitates the supply of such components suitable for such a large-capacity disk driving apparatus 10 having an advantage of reduced occurrence of read/write error. Thus, such an arrangement allows the disk drive apparatus 10 to have a large data capacity. It should be noted that a lubricant oil agent is supplied to the spindle configured to rotationally drive a cutting tool of the cutting machine and other driving components in order to smooth their driving operations. In some cases, such a lubricant oil agent to be applied in order to maintain the functions of the cutting machine side adheres to the workpiece in the cutting process. With the present embodiment, such a lubricant oil agent can be diluted and removed by means of the cutting water agent. Even if hydrocarbon compounds contained in the lubricant oil agent remain as a residue on the workpiece, the amount of such residual lubricant oil agent is negligibly small. Based upon the experimental results, the present inventors have affirmed that such an arrangement is capable of suppressing the amount of such lubricant oil agent that remains as a residue to a stably low level with little variation, which does not lead to read/write error.

FIG. 3 is an explanatory diagram for describing a process sequence using a manufacturing method according to the present embodiment.

An arrangement shown in FIG. 3 includes a step for cutting the workpiece, a step for removing a cutting water agent, an inspection step, and a step for assembling the disk driving apparatus 10. In this example, description will be made regarding a process for manufacturing the hub member 26 as an example, in which an iron material is processed so as to form the hub member 26 in a complete form. In a cutting step 401, for example, rough cutting is performed so as to form the outline of the hub member 26. In a cutting step 402, fine cutting is performed so as to improve the flatness precision of each surface. In a cutting step 403, hole drilling or screw cutting is performed. In each of these steps, cutting is performed while adding the alkaline cutting water agent as described above. It should be noted that the cutting steps in the manufacturing process are described for exemplary purposes only. Also, the rough cutting, fine cutting, hole drilling, and so forth, may be appropriately combined together so as to form a single step, instead of sequentially executing these steps. Also, the order of these steps may be modified. Also, in a case of manufacturing other components such as the base member 12 or the bearing unit, the cutting steps suitable for its structure may be employed.

FIG. 4 is an explanatory diagram for describing an arrangement configured to supply the cutting water agent in the cutting step.

FIG. 4 shows an arrangement in which a workpiece 100, which will become the hub member 26, is fixedly mounted in a chuck 102 of the cutting machine, and is cut by means of a rotating cutting tool 104. Furthermore, a first nozzle 106 and a second nozzle 108 are arranged to supply a cutting water agent 110 such that it reaches the position (cutting position) at which the cutting tool 104 is in contact with the workpiece 100. The first nozzle 106 is configured to supply the cutting water agent 110 to the cutting position, so as to mainly provide a function for reducing the processing friction that occurs between the workpiece 100 and the cutting tool 104, and a function for cooling the workpiece 100 and the cutting tool 104 which are heated in the cutting step. In particular, in order to provide effective cooling, the first nozzle 106 is configured to have a narrow injection opening so as to locally supply the cutting water agent 110 to the cutting position. Furthermore, the second nozzle 108 is also configured to have a narrow injection opening, as with the first nozzle 106, in order to allow it to locally supply the cutting water agent 110 at a high pressure to the cutting position, thereby removing the machining swarf, which is produced in the cutting step, by means of the pressurized cutting water agent 110. Furthermore, the second nozzle 108 is arranged with a nozzle angle adjusted so as to blow away the machining swarf with high efficiency toward a predetermined direction. For example, the first nozzle 106 is arranged to have a acute angle between itself and the direction that is orthogonal to the cutting area, thereby effectively supplying the cutting water agent 110 to the cutting area. On the other hand, the second nozzle 108 is arranged to have an obtuse angle between itself and the direction that is orthogonal to the cutting area, as compared with the first nozzle 106. That is to say, the second nozzle 108 is arranged to effectively supply the cutting water agent 110 along a direction that is close to the horizontal direction that matches the direction along which the machining swarf is to be removed. With such an arrangement, the cutting water agent 110 to be supplied from the first nozzle 106 and the cutting water agent 110 to be supplied from the second nozzle 108 may have the same composition. Such a cutting water agent 110 provides a function for cleaning the workpiece 100.

It should be noted that, by adjusting the angle of a nozzle configured to supply the cutting water agent 110, such an arrangement is capable of supplying the cutting water agent 110 to the cutting position while removing the machining swarf. Such an arrangement requires only a single nozzle. Also, each nozzle configured to supply the cutting water agent 110 may be arranged at a fixed angle. Also, each nozzle may be configured such that its direction is changeable along the vertical direction, along the horizontal direction, or otherwise along both the vertical direction and the horizontal direction. In particular, by configuring the second nozzle 108 such that its injection direction is changeable, such an arrangement is capable of changing the injection state of the cutting water agent 110 so as to adjust the kinetic energy of the cutting water agent 110, thereby providing improved performance for removing the machining swarf and adhered matter.

The cutting tool 104 may be configured using conventional techniques. Also, giving consideration to improving the tool life and improving cutting efficiency, such an arrangement may employ a cutting tool having high hardness and high lubricity, e.g., a diamond-coated cutting edge or a cutting tool subjected to surface coating in order to provide improved hardness and lubricity. Also, such an arrangement may employ a cutting tool having a cutting-edge shape designed giving high priority to its hardness and lubricity.

Returning to FIG. 3, description will be continued regarding the process.

With the process shown in FIG. 3, as a subsequent step after the cutting step 403, a cleaning step 404 is provided. As described above, a liquid which can be assumed to contain substantially no hydrocarbon compounds is employed as a cutting water agent. Based upon the experimental results, the present inventors have discovered that, as a liquid which can be assumed to contain substantially no hydrocarbon compounds, a cutting water agent containing such hydrocarbon compounds at a concentration of 1,000 PPM or less can be effectively employed in order to reduce the occurrence of read/write error. As described above, in some cases, a lubricant oil agent or the like used in the driving system of the cutting machine mixes with the cutting water agent, and such hydrocarbon components adhere to the workpiece 100 with the cutting water agent as the intermediary. Even in this case, the cutting water agent supplied in the cutting step allows such hydrocarbon compounds to be reduced or otherwise removed. In addition, in order to improve the process reliability, the clearing step 404 is provided. However, the cleaning effect provided by the cutting step ensures that the amount of such residual hydrocarbon compounds is very small. Thus, such an arrangement requires the cleaning step 404 to be executed in only a short period of time and requires only a small amount of cleaning liquid. In other words, in a case of providing the cleaning step 404, the allowable level at which the cutting water agent can be assumed to contain a negligibly small amount of (substantially no) hydrocarbon compounds can be relaxed. For example, the present inventors have affirmed that, even if the allowable concentration of hydrocarbon compounds contained in the cutting water agent is relaxed to be 10,000 PPM or less, by providing the cleaning step 404, such an arrangement is capable of reducing the amount of residual hydrocarbon compounds to a level that involves substantially no problems, thereby reducing the occurrence of read/write error. With such an arrangement, the present embodiment requires such a cleaning step 404, but requires only a short period of time for the cleaning step 404, thereby contributing to a reduction in cleaning costs. Furthermore, there is no need to employ a high-performance cleaning liquid, unlike an arrangement in which a residual cutting oil agent must be removed, thereby further reducing the cleaning costs. Furthermore, based upon the experimental results, the present inventors have affirmed that, in a case in which the cutting water agent contains hydrocarbon compounds at a concentration of 1,000 PPM or less, the cleaning step 404 can be omitted, or otherwise with such an arrangement the cleaning can be further simplified and shortened. Moreover, based upon the experimental results, the present inventors have affirmed that, in a case in which the cutting water agent contains hydrocarbon compounds at a concentration of 100 PPM or less, even if the cleaning step is omitted, the variation of the amount of residual hydrocarbon compounds is reduced, thereby reducing the occurrence of read/write error to a level that involves practically no problems. It should be noted that the cleaning liquid to be employed in the cleaning step 404 preferably has substantially the same composition as that of the cutting water. Examples of cleaning performed in the cleaning step 404 include: shower cleaning, dipping cleaning using a cleaning bath, ultrasonic cleaning combined with the dipping cleaning using a cleaning bath, and so forth. As described above, in a case in which sufficient cleaning effects can be obtained by means of the cutting water agent in the cutting step, the cleaning step 404 may be omitted.

As a subsequent step after the cutting step 403 or otherwise the cleaning step 404, a water removal step 405 is provided for removing the cutting water agent or the cleaning water adhering to the workpiece 100. In the water removal step 405, air blowing is performed in which pressurized air is blown onto the workpiece 100. In the water removal step, air blowing is preferably performed while the posture of the workpiece 100 is changed, or otherwise while the position of the air nozzle is changed, in order to remove the cutting water agent that has adhered to the detailed portions of the workpiece 100 (hub member 26) manufactured in a complex uneven shape.

With the present embodiment, two kinds of workpiece inspection steps are provided as subsequent steps after the water removal step 405. For example, in the first inspection step 406, the amount of residual hydrocarbon compounds on the workpiece 100 is measured. It should be noted that, in a case in which experimental results or the like affirm that the amount of residual hydrocarbon compounds on the workpiece 100 is suppressed by means of the cutting water agent to an allowable level that does not become a cause of the occurrence of read/write error, the first inspection step 406 may be configured as a sampling inspection step in which sampling inspection is performed with a predetermined sampling ratio, or otherwise may be omitted. In the second inspection step 407, cutting accuracy inspection is performed for the workpiece 100 subjected to the cutting process. Examples of cutting accuracy inspections executed in the second inspection step 407 include dimensional accuracy inspection, flatness accuracy inspection, and so forth. In the assembling step 408 after the inspection step, the disk driving apparatus 10 is assembled using the components including the workpiece 100 thus subjected to the cutting process. It should be noted that, in a case in which the assembling step for the disk driving apparatus 10 is performed later in a separate sequence, the workpiece 100 thus subjected to the cutting process may be temporarily stored in packing so as to protect the workpiece 100 from the adherence of contaminants.

As described above, by employing an alkaline cutting water agent instead of a cutting oil agent employed in a conventional cutting process, such an arrangement allows the amount of adhering hydrocarbon compounds to be reduced in a simple manner in the manufacturing process for the disk driving apparatus 10, which is a rotating device. Furthermore, such an arrangement allows a cleaning process, which is required in the case of a cutting process using a cutting oil agent, to be omitted or otherwise to be dramatically simplified, thereby providing reduced cleaning costs. Furthermore, the present embodiment does not require a cutting oil agent or a cleaning liquid, which reduces liquid waste disposal costs, thereby reducing the manufacturing costs. Furthermore, with the present embodiment, there is no need to employ a cutting oil agent, and accordingly, such an arrangement reduces uncomfortable odors and contamination of the floor, walls, and other equipment. Thus, such an arrangement provides an improved manufacturing environment for the disk driving apparatus 10 in a simple manner.

It should be noted that description has been made in the aforementioned embodiment regarding an example in which the hub member 26 is manufactured as the workpiece 100. Also, other components of the disk driving apparatus 10 such as the base member 12, the bearing unit 30, etc., may be manufactured in the same way, which provides the same advantages as described above. By applying the cutting water agent according to the present embodiment to the cutting process for at least one from among the base member 12, the hub member 26, and the bearing unit 30, each configured as a component of the disk driving apparatus 10, such an arrangement provides an advantage of reducing the amount of hydrocarbon components that adhere to such a component. Thus, by increasing the number of workpieces manufactured using the cutting water agent, such an arrangement is capable of increasing the effect of the function of suppressing the amount of adhering hydrocarbon components. That is to say, the cutting water agent according to the present embodiment is preferably applied to the cutting processes for all the components of the disk driving apparatus 10 that are to be manufactured by cutting.

Description has been made in the aforementioned embodiment regarding an arrangement configured to manufacture the disk driving apparatus 10 including a fluid bearing unit. Also, the present embodiment can be applied to the manufacture of a ball-bearing rotating device and so forth, which provides the same advantages as described above. Also, the present embodiment can be applied to the manufacture of a read-only CD playback apparatus or a read-only DVD playback apparatus configured as the disk driving apparatus 10, which provides the same advantages as described above.

Description has been made regarding a manufacturing method for a rotating device according to the embodiment. It is needless to say that the present embodiments show only the mechanisms and applications of the present invention for exemplary purposes only, and are by no means intended to be interpreted restrictively. Rather, various modifications and various changes in the layout can be made without departing from the spirit and scope of the present invention defined in appended claims, which can be readily conceived by those skilled in this art.

What is claimed is:

1. A manufacturing method for a rotating device including a hub member on which a recording disk is to be mounted and a base member configured to rotatably support the hub member via a bearing unit, with at least one from among the base member and the hub member as a workpiece, the manufacturing method comprising:
cutting, in which a cutting water agent is applied while the workpiece is being cut;
removing, in which the cutting water agent that remains adhered to the workpiece after cutting is removed; and
assembling, in which the rotating device is assembled using the workpiece after the removing of the cutting water agent.

2. The manufacturing method for the rotating device according to claim 1, wherein the cutting water agent includes a corrosion inhibitor.

3. The manufacturing method for the rotating device according to claim 1, wherein the cutting water agent is controlled so as to have a pH of 8 to 10.

4. The manufacturing method for the rotating device according to claim 1, wherein, before the removing of the cutting water agent, a step is provided in which the workpiece is cleaned using a cleaning liquid that can be assumed to have substantially the same composition as that of the cutting water agent.

5. The manufacturing method for the rotating device according to claim 1, wherein the cutting water agent includes at least one from among phosphoric acid, carboxylic acid, a sulfonate, an alcohol, and an ester.

6. The manufacturing method for the rotating device according to claim 1, wherein the cutting water agent includes an additive agent so as to provide improved lubricity.

7. The manufacturing method for the rotating device according to claim 6, wherein the additive agent configured to provide improved lubricity includes water-soluble cellulose ether.

8. The manufacturing method for the rotating device according to claim 1, wherein the hub member is cut as a workpiece, and wherein the workpiece cutting comprises:
rough cutting, in which rough cutting is performed so as to provide the outline of the workpiece;
fine cutting, in which fine cutting is performed so as to improve the flatness precision of a surface of the workpiece subjected to rough cutting; and
hole cutting, in which a hole is formed in the workpiece,
and wherein, at least the last step from among the rough cutting, fine cutting, and hole cutting is executed with the cutting water agent being applied.

9. The manufacturing method for the rotating device according to claim 1, wherein the cutting of the workpiece comprises:
cooling, in which the cutting water agent is supplied from a first nozzle to a position at which a cutting tool is in contact with the workpiece so as to cool the heated workpiece; and
removing, in which the cutting water agent is supplied from a second nozzle that differs from the first nozzle to a position at which the cutting tool is in contact with the workpiece so as to remove machining swarf that is generated when the workpiece is cut.

10. The manufacturing method for the rotating device according to claim 1, wherein the removing of the cutting water agent is executed by blowing air from an air nozzle to the workpiece while changing the posture of the workpiece.

11. The manufacturing method for the rotating device according to claim 1, wherein the cutting of the workpiece is executed using a processed cutting edge that has been subjected to surface coating so as to provide improved lubricity.

12. A manufacturing method for a rotating device including a hub member on which a recording disk is to be mounted and a base member configured to rotatably support the hub member via a bearing unit, with at least one from among the base member and the hub member as a workpiece, the manufacturing method comprising:
cutting, in which a cutting water agent is applied while the workpiece is being cut;
removing, in which the cutting water agent that remains adhered to the workpiece after cutting is removed; and
assembling, in which the rotating device is assembled using the workpiece after the removing of the cutting water agent,
wherein the cutting water agent includes alkaline water as a principal component.

13. The manufacturing method for the rotating device according to claim 12, wherein the cutting water agent includes a corrosion inhibitor.

14. The manufacturing method for the rotating device according to claim 12, wherein the cutting water agent is controlled so as to have a pH of 8 to 10.

15. The manufacturing method for the rotating device according to claim 12, wherein, before the removing of the cutting water agent, a step is provided in which the workpiece is cleaned using a cleaning liquid that can be assumed to have substantially the same composition as that of the cutting water agent.

16. The manufacturing method for the rotating device according to claim 12, wherein the cutting water agent includes at least one from among phosphoric acid, carboxylic acid, a sulfonate, an alcohol, and an ester.

17. The manufacturing method for the rotating device according to claim 12, wherein the cutting water agent is electrolytically evolved.

18. The manufacturing method for the rotating device according to claim 12, wherein the hub member is cut as a workpiece, and wherein the workpiece cutting comprises:
rough cutting, in which rough cutting is performed so as to provide the outline of the workpiece;
fine cutting, in which fine cutting is performed so as to improve the flatness precision of a surface of the workpiece subjected to rough cutting; and
hole cutting, in which a hole is formed in the workpiece,
and wherein, at least the last step from among the rough cutting, fine cutting, and hole cutting is executed with the cutting water agent being applied.

19. The manufacturing method for the rotating device according to claim 12, wherein the cutting of the workpiece comprises:
cooling, in which the cutting water agent is supplied from a first nozzle to a position at which a cutting tool is in contact with the workpiece so as to cool the heated workpiece; and
removing, in which the cutting water agent is supplied from a second nozzle that differs from the first nozzle to a position at which the cutting tool is in contact with the workpiece so as to remove machining swarf that is generated when the workpiece is cut.

20. The manufacturing method for the rotating device according to claim 12, wherein the removing of the cutting water agent is executed by blowing air from an air nozzle to the workpiece while changing the posture of the workpiece.
